(19) United States
(12) Patent Application Publication
(10) Pub. No.: US 2026/0298759 A1
(43) Pub. Date: Oct. 1, 2026

(54) SYSTEMS AND METHODS FOR LEAK DETECTION

(71) Applicant: Dianomix Inc., Calgary (CA)

(72) Inventor: Marius Ulsamer, Calgary (CA)

(73) Assignee: Dianomix Inc., Calgary (CA)

(21) Appl. No.: 19/630,262

(22) Filed: Mar. 26, 2026

Related U.S. Application Data
(60) Provisional application No. 63/778,922, filed on Mar. 27, 2025.

(51) Int. Cl. G01M 3/02; G01J 5/00; G01J 5/48

(52) U.S. Cl. CPC G01M 3/02; G01J 5/48; G01J 2005/0077

(57) ABSTRACT

A method for vehicle fluid leak detection is provided. The method comprises receiving thermal imaging data obtained by a thermal camera mounted to a moving vehicle. The thermal imaging data comprises thermal imaging of a geographical area traversed obtained during traversal of the geographical area by the vehicle. The method further includes inputting the thermal imaging data to a first neural network trained for identifying and classifying thermal anomalies including at least thermal anomalies indicative of leaked vehicle fluid. The neural network may be trained using data indicative of characteristics of fluid leaks from a moving vehicle. The method further comprises determining, using the first neural network, whether the thermal imaging data is indicative of a fluid leak from the vehicle. The geographical area may comprise a turf area. Methods for determining a turf condition are also provided.

### RELATED APPLICATION

The present disclosure claims priority to U.S. Provisional Patent Application No. 63/778,922, filed on Mar. 27, 2025, the entire contents of which are incorporated herein by reference.

### FIELD OF THE DISCLOSURE

The present disclosure relates to methods and systems for utilizing thermal imaging to detect fluid leaks from a machine or other conditions of a geographical area.

### BACKGROUND

Golf turf maintenance equipment such as mowers, rollers, golf ball pickers, and other specialized equipment, often relies on fluids and hydraulic components. Due to the high value placed on turf quality and appearance by both golf course operators and their clientele, extra care must be taken to avoid inadvertent damage. Fluid leaks, whether from hydraulic systems or coolant lines, pose a risk of harming the turf and degrading its visual and functional quality. These leaks can be especially problematic because they are often difficult for human operators to detect in time. Existing built-in detection methods for hydraulic leaks, where available, are often unreliable. Most approaches rely on pressure or fluid level sensors, which typically lack the sensitivity required to detect small or slow-developing leaks. As a result, leak detection frequently depends on visual identification by the operator, which is not always timely or effective. If left undetected, these leaks can not only damage the turf but also lead to costly damage to the equipment itself.

An additional emerging challenge involves autonomous turf maintenance equipment. In the absence of a human operator, leaks, whether from hydraulic fluid or other fluids, are likely to go undetected. Without a reliable automatic detection system in place, such leaks can almost inevitably result in excessive turf damage, negative environmental impact, and significant equipment failure or costly repairs.

### SUMMARY

According to an aspect, there is provided a method for vehicle fluid leak detection, the method comprising: receiving thermal imaging data obtained by a thermal camera mounted to a vehicle, the thermal imaging data comprising thermal imaging of a geographical area obtained during traversal of the geographical area by the vehicle; inputting the thermal imaging data to a first neural network trained for identifying and classifying thermal anomalies including at least thermal anomalies indicative of leaked vehicle fluid; determining, using the first neural network, whether the thermal imaging data is indicative of a fluid leak from the vehicle.

In some embodiments, the method further comprises obtaining the thermal imaging data by the thermal camera as the vehicle traverses the geographical area.

In some embodiments, the first neural network has been trained using training data, and at least some of the training data is indicative of characteristics of the thermal anomalies indicative of the moving vehicle fluid leaks.

In some embodiments, the method further comprises: training the first neural network using training data.

In some embodiments, at least some of the training data is indicative of characteristics of the thermal anomalies indicative of the leaked vehicle fluid.

In some embodiments, the training data comprises real or simulated thermal imaging indicative of fluid leaks from a moving vehicle.

In some embodiments, the fluid leak from the vehicle comprises hydraulic fluid.

In some embodiments, the thermal camera, when mounted to the vehicle, has a field of view including ground behind or proximate to the rear of the vehicle.

In some embodiments, the method further comprises obtaining location data indicating location of the vehicle during the obtaining the thermal imaging data using the thermal camera.

In some embodiments, the method further comprises generating a thermal map of the geographical area using the thermal imaging data and the location data.

In some embodiments, the geographical area comprises a turf area, and the method further comprises analyzing the thermal map using a second neural network to identify one or more turf conditions.

In some embodiments, the first and second neural networks are the same neural network.

In some embodiments, the turf condition comprises an irrigation condition.

In some embodiments, the method further comprises transmitting the thermal map to a remote computer system.

In some embodiments, the second neural network is implemented by the remote computer system.

In some embodiments, the method further comprises receiving optical sensor data from one or more optical sensors of the vehicle, and inputting the optical sensor data into the neural network, wherein optical sensor data and the thermal imaging data are processed by the first neural network for the determining whether the thermal imaging data is indicative of a fluid leak from the vehicle.

In some embodiments, the method further comprises, if the thermal imaging data is determined to be indicative of the fluid leak, shutting down the vehicle responsive to detecting the fluid leak.

In some embodiments, the method further comprises detecting, using the first neural network, a shut down condition as a function of the thermal imaging data, and shutting down the vehicle responsive to detecting the shut down condition.

According to another aspect, there is provided a method comprising: obtaining, by a thermal camera mounted to a moving vehicle, thermal imaging of a turf area, thereby generating thermal imaging data; obtaining, while obtaining the thermal imaging, location data indicating location of the vehicle; generating a thermal map of the turf area using the thermal imaging data and the location data; analyzing the thermal map using a neural network to identify one or more turf conditions.

According to another aspect, there is provided a system comprising: one more processors; and memory coupled to the one or more processors and having stored thereon processor-executable instructions that, when executed by the one or more processors, cause the one or more processors to implement one or more of the methods described herein.

Other aspects and features of the present disclosure will become apparent to those ordinarily skilled in the art upon review of the following description of the specific embodiments of the disclosure.

### BRIEF DESCRIPTION OF THE DRAWINGS

The present disclosure will be better understood having regard to the drawings in which:

FIG. 1A is side view an example golf turn maintenance machine having a thermal camera mounted thereon according to some embodiments;

FIG. 1B is front perspective view the example golf turn maintenance machine of FIG. 1A;

FIG. 2 is a functional block diagram of some components of the vehicle of FIGS. 1A and 1B and an external computer system, according to some embodiments;

FIG. 3 is a functional block diagram of the computer system in FIG. 2, according to some embodiments;

FIG. 4 is a functional block diagram of an example control system of the vehicle according to some embodiments;

FIG. 5 is a flow chart of an example method according to some embodiments;

FIG. 6 is a flow chart of another example method according to some embodiments;

FIGS. 7A and 7B are perspective views of an example thermal camera unit according to some embodiments; and

FIG. 8 illustrates an example of thermal imaging data in the form of a thermal map, captured by a thermal camera mounted on a vehicle, and processed by a computer system in accordance with some embodiments.

### DETAILED DESCRIPTION

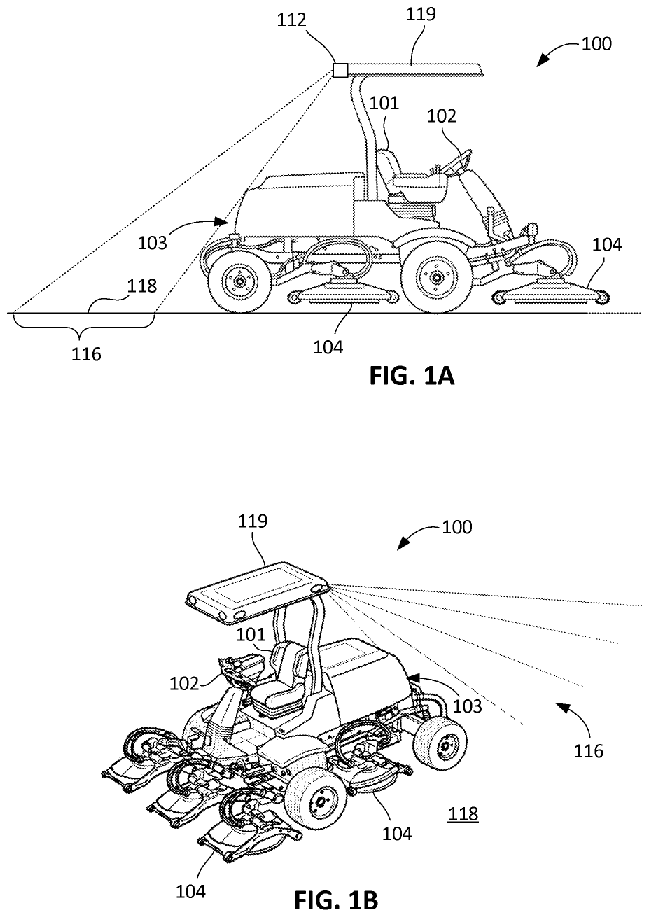

FIGS. 1A and 1B show an example golf turf maintenance vehicle 100. The vehicle 100 includes equipment 104 for performing turf maintenance, such as mower equipment or golf ball picking equipment. The vehicle 100 may include a seat 101 for an operator, typical manual controls for navigation, such as a steering wheel 102 (connected to a steering column), throttle, brake, engine start and stop controls, and more. The vehicle 100 may also include controls for the equipment 104. The vehicle 100 may typically be a vehicle capable of being driven over the turf to perform the associated maintenance task.

The vehicle 100 has a thermal camera 112 (shown in FIG. 1A) mounted to the vehicle 100 and positioned for taking thermal images of the ground 118 traversed by the vehicle 100. The thermal camera in this example is positioned to take thermal images of the ground 118 behind the vehicle 100 (in an area 116 behind the vehicle 100 in this example). The thermal imaging may not be directly behind the vehicle and may include areas proximate the rear of the vehicle 100, such as near the side of the rear of the vehicle 100. The field of view of the thermal camera 112 may vary.

In FIG. 1A the thermal camera 112 is shown at or near a rear end of a canopy 119, positioned for imaging the ground near the rear 103. However, the thermal camera 112 may be mounted in other positions in other embodiments (for example, at or near the rear 103 of the vehicle). The thermal camera 112 may be mounted to other locations on the vehicle 100 in other embodiments. Most fluids used in such equipment, such as hydraulic fluid, coolant, and engine oil, typically operate at elevated temperatures ranging from 60° C. to 90° C. (140° F. to 194° F.). Thus, a thermal camera may be particularly suited for real-time leak detection as described herein.

The term “thermal camera” as used herein may refer to an infrared (IR) camera, thermographic camera, or any imaging or sensing device configured to detect electromagnetic radiation within the infrared spectrum and convert such radiation into image data representing temperature differentials or relative thermal patterns. Such devices may include, without limitation, sensors based on uncooled microbolometer arrays, thermopile arrays, pyroelectric detectors, cooled photon-detecting infrared sensors, quantum infrared detectors, or any other technology capable of sensing thermal radiation in the infrared spectrum. The term further encompasses devices operating in any infrared wavelength band, including near-infrared (NIR), short-wave infrared (SWIR), mid-wave infrared (MWIR), and long-wave infrared (LWIR), as well as future infrared sensing technologies capable of generating spatially resolved thermal information.

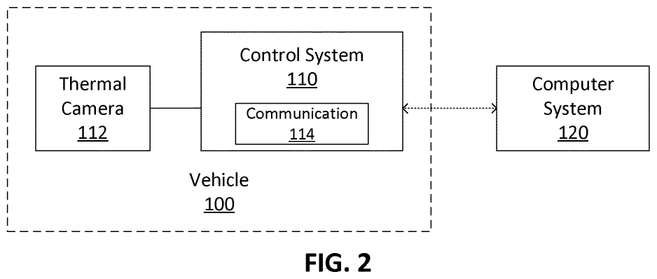

In some embodiments, the vehicle includes a computerized control system 110 (shown in FIG. 2). The thermal camera 112 generates thermal imaging data that may be received by the control system 110 of the vehicle 100. The control system 110 may transmit the thermal imaging data to a remote computer system 120 (shown in FIG. 2). The control system 110 is described in more detail below. In other embodiments, the thermal imaging data may be transmitted from the thermal camera 112 to the computer system 120, and the control system 110 may be omitted. In other embodiments, the data is entirely processed locally on the control system 110 without requiring remote communication to process the data, and the computer system 120 may be omitted.

FIG. 2 is a functional block diagram illustrating the thermal camera 112, the control system 110, and one or more communication components 114. In some embodiments, the thermal camera 112 and control system 110 are integrated into the same physical unit. The physical unit may also include additional hardware such as, but not limited to, additional machine vision components. The one or more communication components 114 may include one or more transceivers (receivers and/or transmitters) or other equipment for communication over a network such as the Internet and/or Wireless Local Area Network (WLAN). For example, the control system 110 may communicate with the computer system 120 over a Wi-Fi or cell network. In other embodiments, the control system 110 may communicate with the computer system 120 via the machine operator's mobile phone, which may be connected to the Internet over a cell network. The control system 110 might establish a connection to the operator's phone using Wi-Fi or Bluetooth (e.g., BLE). The control system 110 may control the thermal camera 112 to capture thermal imaging data as the vehicle traverses a geographical area, such as a golf course. Thermal data might be primarily processed in real time by the control system 110 to enable low-latency detection, allowing immediate alerts to be communicated to either the human operator or the autonomous system controlling the vehicle 100. The system may be configured to automatically shut down the vehicle's engine in certain situations (based at least partly on analyzing the thermal imaging data) to minimize further damage or risk. The control system 110 may also transmit the thermal imaging data to a computer system 120 via communication component(s) 114. The computer system 120 may use the thermal imaging data for further analysis. For example, the thermal imaging data may be analyzed to identify additional turf conditions.

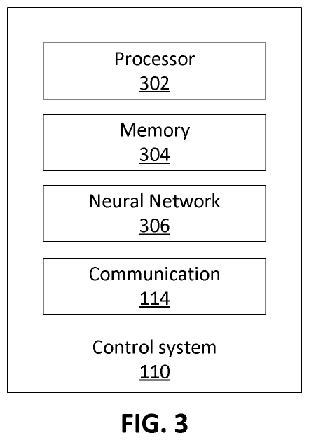

FIG. 3 is a functional block diagram of the control system 110. The control system 110 comprises of one or more processors 302 and memory 304. The memory 304 stores processor-executable instructions that, when executed, cause the processor(s) 302 to implement methods described herein. The control system 110 includes a neural network 306, The neural network 306 may be implemented by the processor(s) 302 and memory 304, or by other computing hardware. The neural network 306 is trained for identifying and classifying thermal anomalies in thermal ground images. Identifying a thermal anomaly may include identifying that thermal image data includes or is indicative of the thermal anomaly. Classifying the thermal anomaly may include determining a class or type of the thermal anomaly. For example, classifying the thermal anomaly may comprise determining whether the thermal anomaly is indicative of leaked fluid from a vehicle.

The thermal imaging data is input to the neural network, and the neural network 306 determines whether the thermal imaging data is indicative of a fluid leak from the vehicle. The neural network 306 may classify a thermal anomaly as a leak and may further identify the type of fluid as a function of the thermal imaging data. Additional details of the analysis of the thermal imaging data are described below.

The term “neural network” as used herein may refer to any computer-implemented machine learning or artificial intelligence model configured to process input data and generate an output, prediction, classification, regression result, segmentation, detection, or decision based on learned parameters or computational rules. Such models may include, without limitation, artificial neural networks comprising interconnected processing units or layers that apply weighted transformations and activation functions to input data. The term further encompasses convolutional neural networks (CNNs), recurrent neural networks (RNNs), multilayer perceptrons (MLPs), transformer-based architectures, graph neural networks (GNNs), spiking neural networks, attention-based models, and other deep learning architectures. In addition, the term may include other machine learning approaches capable of performing similar inference tasks, including support vector machines, decision trees, random forests, gradient boosting models, probabilistic models, clustering algorithms, or hybrid systems combining multiple computational methods. The neural network 306 in this disclosure may therefore represent any suitable computational model configured for analyzing sensor data, including image data, and producing outputs such as classifications, detections, segmentations, regressions, or other learned interpretations of the input data.

The neural network 306 may differentiate or distinguish between fluid leaks and other thermal anomalies. For example, sunlight, shadows, puddles, condensation, irrigation, and other environmental factors may cause thermal anomalies in thermal imaging data, and the trained neural network 306 may distinguish thermal anomalies caused by these types of environmental factors from thermal anomalies corresponding to a fluid lead from a vehicle. The trajectory of the machine influences the shape of any resulting fluid leak on the soil, often producing trails or streak-like thermal contours that follow the path of movement. These distinctive patterns tend to differ from the more irregular or localized temperature anomalies typically caused by non-vehicle-related sources. Fluid leaks may also tend to have certain temperature ranges, etc. depending on the type(s) of fluid and other factors. The trained neural network 306 may, thus, recognize such characteristics and/or other characteristics to classify the anomaly as a fluid leak from the moving machine.

In other embodiments, the remote computer system 120 may include the neural network 306 rather than control system, and the computer system 120 may perform the processing and analysis of the thermal imaging data (rather than the control system 110).

The control system 110 in the embodiment of FIGS. 2 and 3 also includes the communication components 114 in this example, although the communication components may be external to the control system 110 in other embodiments.

Turning again to FIG. 2, the computer system 120 may be remote from the vehicle and might be connected to the network (Internet) for receiving data from the control system 110 of the vehicle. The computer system 120 may include distributed hardware in some embodiments. The computer system may include one or more servers or other network components. In other embodiments, the computer system 120 may part of the vehicle 100, or the computer system 120 may include the controller 110. Other combinations of hardware and/or software may be used in other embodiments. For example, the computer system 120 may be implemented as more servers, and one or more client devices (desktops, laptops, mobile phones, tablets, etc.) may communicate with the server(s) over a network.

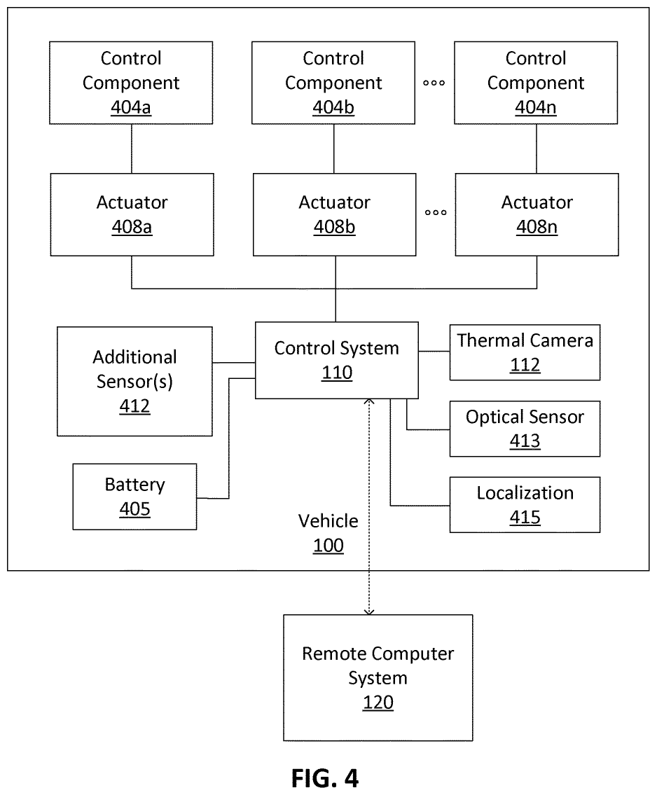

FIG. 4 is a functional block diagram of an example implementation of machine perception and control components of the example vehicle 100 of FIG. 1. In this example, the vehicle 100 is configured for automated or remote control. However, embodiments of the present disclosure are not limited to the specific vehicle 100 of FIG. 1A or to vehicles configured for remote or automated control.

The vehicle 100 may be a golf turf maintenance machine including specialized golf turf maintenance equipment, for example, although embodiments of this disclosure may be applied to other types of machines. The vehicle 100 in this example includes control components 404a to 404n. The control components 404a to 404n may include one or more of: a steering wheel, a throttle, a brake component, engine start/stop controls, and/or controls for operating the golf turf equipment of the vehicle 100, such as mowing or golf ball picking equipment. The vehicle 100 also includes a battery 405 in this example. The skilled person will appreciate that the vehicle 100 will typically include other equipment not specifically shown in FIG. 4, such as an engine or motor (e.g. electric or gas powered), wheels or other locomotion means, etc.

The vehicle 100 in this example further includes one or more actuator apparatuses 408a to 408n coupled to the various control components of the vehicle 100. In some embodiments, the actuator devices may include, but are not limited to, one or more of the following examples: cable actuator device(s); lever(s); linear actuator(s); rotator actuator(s); hydraulic actuator(s); and/or combinations thereof.

The vehicle 100 further includes the control system 110 of FIGS. 2 and 3. The control system 110 is operatively connected to the one or more actuator apparatuses 408a to 408n. The control system 110 generates control signalling to operate the one or more actuator apparatuses 408a to 408n during an automated or remote control mode of operation.

The vehicle 100 further includes the thermal camera 112, which may be mounted to the vehicle 100 for capturing thermal imaging of the ground traversed by the vehicle 100. The control system 110 may control the thermal camera 112 to capture thermal imaging data as the vehicle traverses a geographical area, such as a golf course. The scanning of the geographical area might occur concurrently with the vehicle's regular tasks, for example, while a fairway mowing unit performs its routine daily mowing operation, ensuring that the entire fairway surface is thoroughly and systematically scanned. The control system 110 may also transmit the thermal imaging data to an external computer system 120 (via communication component(s) 114) for further processing and analysis, such as additional turf conditions analysis. However, the initial processing and analysis may be at least partly performed by the control system 110 or other computer components of the vehicle 100 in other embodiments.

The thermal camera may be considered a machine perception component. The vehicle 100 may further include sensors such as additional machine perception components. The additional machine perception components may include, but are not limited to, one or more of: one or more optical sensor(s) 413 (e.g. RGB-D depth camera(s), and/or IR and thermal cameras, etc.), one or more localization sensor(s) 415 such as GNSS receivers (e.g., GPS, Galileo, GLONASS, BeiDou, etc.) inertial measurement units (IMUs), and/or other sensor(s) 412 for monitoring the environment and/or machine operation. The neural network 306 (FIG. 3) may also receive data from one or more of the optical sensors 413, and the combined optical sensor data and thermal imaging data may be processed by the neural network for leak detection or identifying other turf conditions.

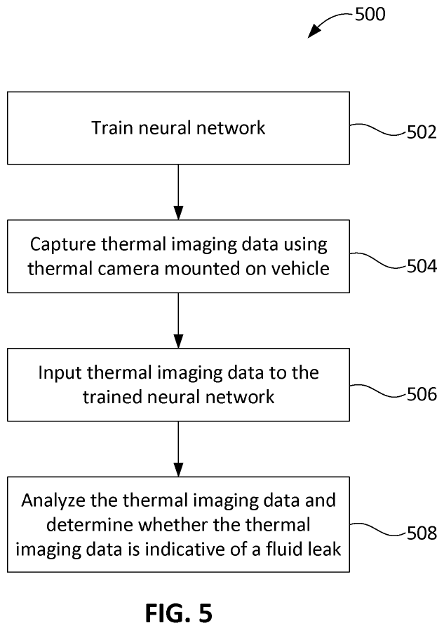

FIG. 5 is a flowchart of an example method 500 according to some embodiments. The method is described with reference to the vehicle 100 and control system 110 shown in FIGS. 1 to 4 for illustrative purposes.

Optionally, at block 502, the method 500 may include training a neural network (such as the neural network 306 in FIG. 3) for identifying and classifying thermal anomalies in thermal imaging data. The neural network may be trained with training data comprising thermal imaging of a ground surface (e.g. turf surface) with fluid leak from a moving vehicle. The training data may include real or simulated leaks from a moving vehicle. The training data may be generated based on the specific environment in which the machine (vehicle) is expected to operate, such as turf, weather, lighting, and other characteristics. The training data may also be generated based on a knowledge of the expected direction of travel of the machine, and the resulting path or contours that leaked fluid may have as a function of that movement. Since thermal imaging is dependent on the position and orientation of a thermal camera (or other thermal sensor), the training data may be generated as a function of a specified camera position and orientation (relative to the machine/ground).

The neural network may thereby learn, for example, characteristics of thermal anomalies indicative of fluid leaks, including shape, contour, temperature, etc. The neural network may be trained to specifically identify vehicle fluid leaks (e.g. from a moving vehicle). Such fluid leaks may include, but are not limited to, hydraulic fluid leaks. The neural network may be trained to identify other types of fluids that may leak from a vehicle.

At block 504, thermal imaging data of a geographical area, such as a turf area, is obtained. The thermal imaging data may have been previously captured and stored in a database, and obtaining the data may comprise receiving the data from a database (e.g. memory of the control system 110 in FIG. 4, or memory of another computer system). Obtaining the data may include capturing using the thermal camera 112 on the vehicle 100. To capture the thermal imaging data, the vehicle 100 may traverse the ground (e.g. in a pattern) to provide suitable coverage of the geographical area by the thermal camera. The geographical area may comprise turf of a golf club, as discussed above.

Location data may also be obtained while the thermal imaging data is captured. For example, the vehicle 100 may include a GNSS system or other geolocation system that generates precise location information concurrently with capturing the thermal imaging. The thermal imaging data may be received by the computer system 120 as the data is captured, for example. The thermal imaging data comprises thermal imaging of ground, such as an area of golf turf, traversed by the vehicle 100.

At block 506, the thermal imaging data is input to the neural network. Various types of neural networks might be employed, including supervised trained convolutional neural networks (CNNs) for image classification, or segmentation of leaks; autoencoders for unsupervised anomaly detection; recurrent neural networks (RNNs) or LSTMs for analyzing temporal patterns in thermal video; vision transformers (ViTs) for advanced spatial analysis; and multimodal neural networks that combine thermal data with inputs from other sensors (e.g., RGB cameras) to improve detection robustness. Conventional computer vision techniques, applied to thermal imagery, such as thermal edge detection, temperature gradient analysis, or spatiotemporal tracking that matches the machine trajectory, may also be used in parallel to enhance detection robustness and provide redundancy in cases where neural network-based thermal analysis might be inconclusive.

At block 508, the neural network analyzes the thermal imaging data and determines whether the thermal imaging data is indicative of a fluid leak from the vehicle.

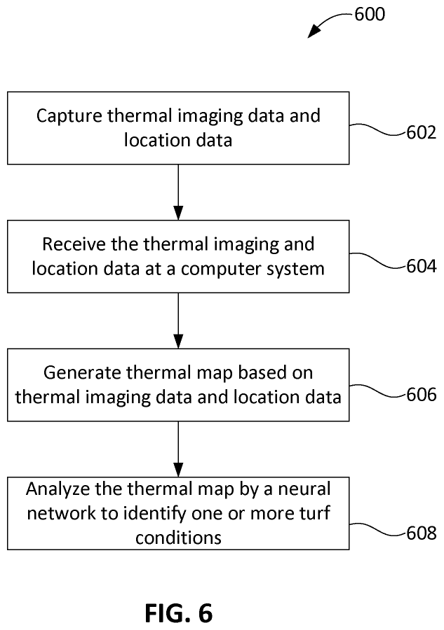

FIG. 6 is a flow chart of an example method for 600 according to some embodiments. The method 600 may be performed by the computer system 120 shown in FIGS. 2 to 4.

At 602, optionally, the thermal imaging data and location data are captured as described above with respect to block 504 of FIG. 5. The thermal imaging data in this example may be obtained by scanning a golf turf area using the vehicle 100 and thermal camera 112 of FIG. 1.

At block 604, the thermal imaging data and the location data are received by the computer system 120.

At block 606 a thermal map of the geographical area is generated using the thermal imaging data and the location data. Generating the thermal map may comprise stitching the thermal imaging data as a function of the location data. The map may include one or more fairways of a golf course, for example.

At block 608, the thermal map is analyzed to identify one or more turf conditions. The analyzing may be performed using a neural network (such as the same neural network as used in FIG. 5, or a different neural network). One example of a detectable condition is irrigation status. A thermal map can reveal hot spots, areas with elevated temperatures, indicative of insufficient irrigation, where additional watering may be required. Beyond general irrigation needs, the system may also detect localized irrigation issues, such as malfunctioning or misaligned sprinklers, clogged nozzles, or uneven coverage due to pressure variations. Furthermore, thermal patterns may indicate other turf-related problems, such as soil compaction, fungal activity, pest infestations, or turf stress caused by heavy equipment or high foot traffic. By interpreting these thermal anomalies, the system may support more precise and proactive turf maintenance, potentially optimizing resource use and preserving turf quality.

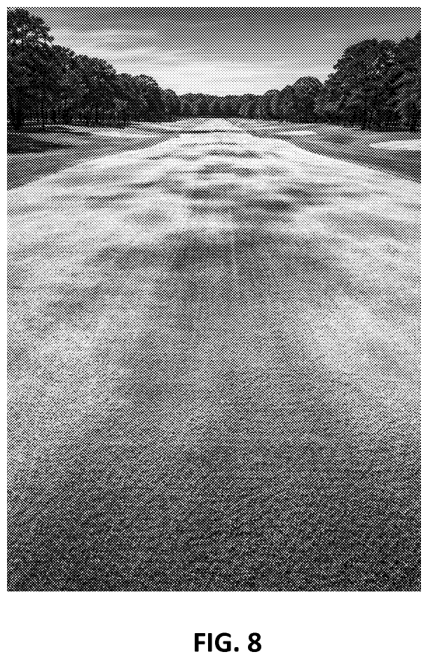

Optionally, the thermal map may be stored in a database. A plurality of thermal maps generated from scans at different times or dates may be generated and changes to the thermal map over time may be tracked for monitoring the condition of the turf. Thermal maps and analysis results may be accessed remotely by customers through a web browser, using account-based authentication, for example. FIG. 8 illustrates a portion of a non-limiting example thermal mapping that may be generated and analysed, according to some embodiments. The thermal map may be generated from data captured by a thermal camera mounted on the vehicle and processed by the computer system.

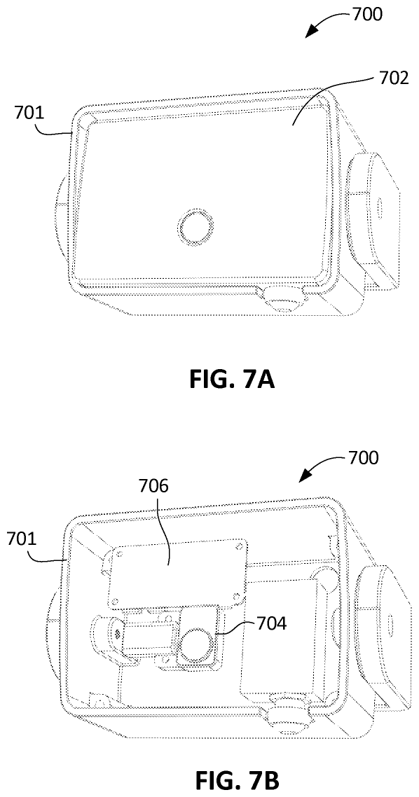

FIGS. 7A and 7B illustrate an example thermal camera unit 700, although embodiments are not limited to this particular configuration. The camera unit 700 in this example comprises a housing 701 and thermal camera 704 (FIG. 7B). A front cover 702 shown in FIG. 7A is removed in FIG. 7B, to show the thermal camera 704 and a compact local processing and communication unit 706, which may include control system 110 shown in FIGS. 2, 3 and 4. The thermal camera 704 may collect thermal imaging data in accordance with the methods and principles described herein. The thermal camera unit 700 unit may be installed as the camera 112 shown in FIGS. 1A, 2 and 4. For example, the camera unit 700 may be mounted on a vehicle for collecting imaging data for use by a neural network in classifying thermal anomalies such as leaks. The thermal camera unit 700 may be a dedicated enclosure for the thermal camera 704 to improve ruggedness and environmental protection. This thermal camera unit 700 may also integrate additional hardware such as onboard computing, memory and wireless communication modules. Such additional hardware may allow the thermal camera unit 700 to operate independently. For example, the thermal camera unit 700 may include computing hardware that implements one or more methods described herein.

Elements referred to herein in the singular may be plural and vice versa, except wherein indicated otherwise either explicitly or inherently by context. As used herein the terms “a,” “an”, and “the” may include plural referents unless the context clearly dictates otherwise. As used herein, the term “coupled” are intended to encompass components that are directly connected to one another as well as components that are indirectly connected with one or more other components therebetween, unless the context clearly dictates otherwise.

It is to be understood that a combination of more than one of the approaches described above may be implemented. Embodiments are not limited to any particular one or more of the approaches, methods or apparatuses disclosed herein. One skilled in the art will appreciate that variations, alterations of the embodiments described herein may be made in various implementations without departing from the scope of the claims.

1. A method for vehicle fluid leak detection, the method comprising:
receiving thermal imaging data obtained by a thermal camera mounted to a vehicle, the thermal imaging data comprising thermal imaging of a geographical area obtained during traversal of the geographical area by the vehicle;
inputting the thermal imaging data to a first neural network trained for identifying and classifying thermal anomalies including at least thermal anomalies indicative of leaked vehicle fluid;
determining, using the first neural network, whether the thermal imaging data is indicative of a fluid leak from the vehicle.

2. The method of claim 1, further comprising obtaining the thermal imaging data by the thermal camera as the vehicle traverses the geographical area.

3. The method of claim 1, wherein the first neural network has been trained using training data, and at least some of the training data is indicative of characteristics of the thermal anomalies indicative of the moving vehicle fluid leaks.

4. The method of claim 1, further comprising training the first neural network using training data.

5. The method of claim 4, wherein at least some of the training data is indicative of characteristics of the thermal anomalies indicative of the leaked vehicle fluid.

6. The method of claim 4, wherein the training data comprises real or simulated thermal imaging indicative of fluid leaks from a moving vehicle.

7. The method of claim 1, wherein the fluid leak from the vehicle comprises hydraulic fluid.

8. The method of claim 1, wherein the thermal camera, when mounted to the vehicle, has a field of view including ground behind or proximate to a rear of the vehicle.

9. The method of claim 2, further comprising obtaining location data indicating location of the vehicle during the obtaining the thermal imaging data using the thermal camera.

10. The method of claim 9, further comprising generating a thermal map of the geographical area using the thermal imaging data and the location data.

11. The method of claim 10, wherein the geographical area comprises a turf area, and the method further comprises analyzing the thermal map using a second neural network to identify one or more turf conditions.

12. The method of claim 11, wherein the first and second neural networks are the same neural network.

13. The method of claim 11, wherein the turf condition comprises an irrigation condition.

14. The method of claim 10, further comprising transmitting the thermal map to a remote computer system.

15. The method of claim 11, wherein the second neural network is implemented by the remote computer system.

16. The method of claim 1, further comprising receiving optical sensor data from one or more optical sensors of the vehicle, and inputting the optical sensor data into the neural network, wherein optical sensor data and the thermal imaging data are processed by the first neural network for the determining whether the thermal imaging data is indicative of a fluid leak from the vehicle.

17. The method of claim 1, wherein the method further comprises, if the thermal imaging data is determined to be indicative of the fluid leak, shutting down the vehicle responsive to detecting the fluid leak.

18. The method of claim 1, further comprising detecting, using the first neural network, a shut down condition as a function of the thermal imaging data, and shutting down the vehicle responsive to detecting the shut down condition.

19. A method comprising:
obtaining, by a thermal camera mounted to a moving vehicle, thermal imaging of a turf area, thereby generating thermal imaging data;
obtaining, while obtaining the thermal imaging, location data indicating location of the vehicle;
generating a thermal map of the turf area using the thermal imaging data and the location data; and
analyzing the thermal map using a neural network to identify one or more turf conditions.

20. A system comprising:
one more processors; and
memory coupled to the one or more processors and having stored thereon processor-executable instructions that, when executed by the one or more processors, cause the one or more processors to implement a method comprising:
receiving thermal imaging data obtained by a thermal camera mounted to a vehicle, the thermal imaging data comprising thermal imaging of a geographical area obtained during traversal of the geographical area by the vehicle;
inputting the thermal imaging data to a first neural network trained for identifying and classifying thermal anomalies including at least thermal anomalies indicative of leaked vehicle fluid;
determining, using the first neural network, whether the thermal imaging data is indicative of a fluid leak from the vehicle.
